(19) United States
(12) Patent Application Publication
(10) Pub. No.: US 2014/0297804 A1
(43) Pub. Date: Oct. 2, 2014

(54) CONTROL OF MULTIMEDIA CONTENT STREAMING THROUGH CLIENT-SERVER INTERACTIONS

(71) Applicant: Sonic IP. Inc., Santa Clara, CA (US)

(72) Inventors: Abhishek Shivadas, San Diego, CA (US); Andrew Wood, San Diego, CA (US)

(73) Assignee: Sonic IP. Inc., Santa Clara, CA (US)

(21) Appl. No.: 13/852,228

(22) Filed: Mar. 28, 2013

(51) Int. Cl. H04L 29/06

(52) U.S. Cl. CPC H04L 65/60
USPC 709/219

(57) ABSTRACT

A real-time server (RTS) controls on-demand, live, and real-time streaming of multimedia content from network services to a client. The RTS receives a request to stream the multimedia content to the client. In response, the RTS causes an encoder to encode successive blocks of the content to produce encoded files, upload the encoded files to a download server, and identify the uploaded files to the RTS. The RTS receives, from the client, a playlist request that relates to the content and includes encoded file selection criteria. In response, the RTS selects among the uploaded files based on the selection criteria, and sends a playlist identifying the selected files to the client. The download server services access requests from the client to download the selected files identified in the playlist.

### BACKGROUND

Distribution of multimedia content (also referred to herein as “media” and/or “program(s)”), such as movies and the like, from network services to a client device may be achieved through adaptive bitrate streaming of the content. Typically, the content may be encoded at different bitrates and resolutions into multiple bitrate streams that are stored in a download server associated with the network services. Conventional adaptive bitrate streaming includes determining an available streaming bandwidth at the client device, and then streaming, i.e., downloading, a selected one of the different bitrate streams from the download server to the client device based on the determined available bandwidth.

From the perspective of the download server, streaming content includes transmitting or downloading encoded content in response to requests from the client device. From the perspective of the client device, streaming content includes continuously requesting and receiving the encoded content from the download server, and storing the received encoded content in a buffer for subsequent decoding and presentation or playback. The buffered content, once decoded, may be presented, i.e., played back, in audio-visual form, for example.

In the above-described scenario, the download server serves simply as a mass storage device, a repository for the encoded content, with limited processing and communication capability. For example, communication between the download server and the client device is limited to the simple-back-and-forth exchange of requests and downloads mentioned above. Therefore, once a streaming session has been initiated, the download server does not provide insight into the properties of the encoded content stored therein beyond that which is necessary to provide the client with access to that content. As a result, the client device is forced to manage adaptive bitrate streaming, e.g., request data downloads and select between bitrates, based primarily on the limited information that can be assessed only at the client device. This limits the effectiveness with which the client device is able to manage the streaming.

Streaming of content may include streaming live content, such as live programs or video recordings. Such streaming is referred to herein as live streaming. Live streaming involves repeatedly encoding live content as it becomes available and then downloading the encoded content from the download server to the client device. Live streaming is dynamic and unpredictable because, for example, the point at which the content ends is often indeterminate. The limited communication capability supported by the download server makes it difficult for the client device to effectively manage live streaming.

### BRIEF DESCRIPTION OF THE DRAWINGS

FIG. 1 is a block diagram of an example network environment in which embodiments directed to controlling multimedia content streaming through server-client interactions may be implemented.

FIG. 2 is an illustration of an example encoded video program generated by an encoder of FIG. 1.

FIG. 3 is an illustration of a container file that encodes a single audio stream.

FIG. 4 is an illustration of a container file that encodes multiplexed audio and video streams.

FIG. 5 is an illustration of a container file that encodes multiplexed video, audio, text, and metadata streams.

FIG. 6 is a sequence diagram of example high-level interactions between network services and a client device used to initiate or start-up streaming in streaming embodiments.

FIG. 7 is a sequence diagram of example high-level interactions between the network services and the client device used to playback content in streaming embodiments, once a streaming session has been initiated.

FIG. 8 is a sequence diagram of example high-level interactions between the network services and the client device used to indicate that the content to be streamed has come to an end in streaming embodiments.

FIG. 9 is an example ProfileSMIL message.

FIG. 10 is an example PlaylistSMIL message.

FIG. 11 is a block diagram of a parallel encoder, according to an embodiment.

FIG. 12A is a flowchart of an example method of controlling streaming from network services to a client device, from the perspective of, i.e., implemented in, a real-time server (RTS).

FIG. 12B is a flowchart of an example method of controlling streaming from network services to a client device, from the perspective of an RTS, an encoder, and a download server of the environment of FIG. 1.

FIG. 13 is a block diagram of an example computer system corresponding to any of the network servers in the environment of FIG. 1.

FIG. 14 is a block diagram of an example system representing a client device.

FIG. 15 is a block diagram of an example computer system.

FIG. 16 is a block diagram of an example multi-server environment for hosting instructions sets in distinct computer systems.

In the drawings, the leftmost digit(s) of a reference number identifies the drawing in which the reference number first appears.

### DETAILED DESCRIPTION

Table of Contents

| | | |
|---|---|---|
| 1 | Network Environment | -7- |
| 2 | Container Files - Streaming Sources | -11- |
| 3 | Sequence Diagrams | -14- |
| 3.1 | Start-up Sequence | -14- |
| 3.2 | Playback Sequence | -17- |
| 3.3 | End of Stream Sequence | -18- |
| 4 | Message Definitions | -19- |
| 4.1 | ProfileSMIL and PlaylistSMIL Message Definitions | -19- |
| 4.1.1 | ProfileSMIL | -19- |
| 4.1.2 | PlaylistSMIL | -20- |
| 4.1.2.1 | Structure | -20- |
| 4.1.2.2 | Seq Element | -20- |
| 4.1.2.3 | MediaSize parameter | -21- |
| 4.1.2.4 | ClipBegin and ClipEnd Attribute (Time Code) | -22- |
| 4.1.2.5 | Example PlaylistSMIL | -22- |
| 4.2 | Real-Time Server RESTful/HTTP Message Interface | -23- |
| | for Start, StartEncode, GetPlaylist, | |
| | GOPEncodeCompleted, and EOS Messages | |
| 4.2.1 | Overview | -23- |
| 4.2.2 | Start (Begin Playback) | -24- |
| 4.2.3 | StartEncode (Begin Encode) | -24- |
| 4.2.4 | GetPlaylist (Request Playlist) | -25- |
| 4.2.5 | GOPEncodeCompleted | -25- |
| 4.2.6 | EOS message | -26- |
| 5 | Parallel Encoder | -27- |
| 6 | Client Device Streaming | -27- |
| 7 | Method Flowcharts | -29- |
| 8 | Systems | -31- |

### 1 Network Environment

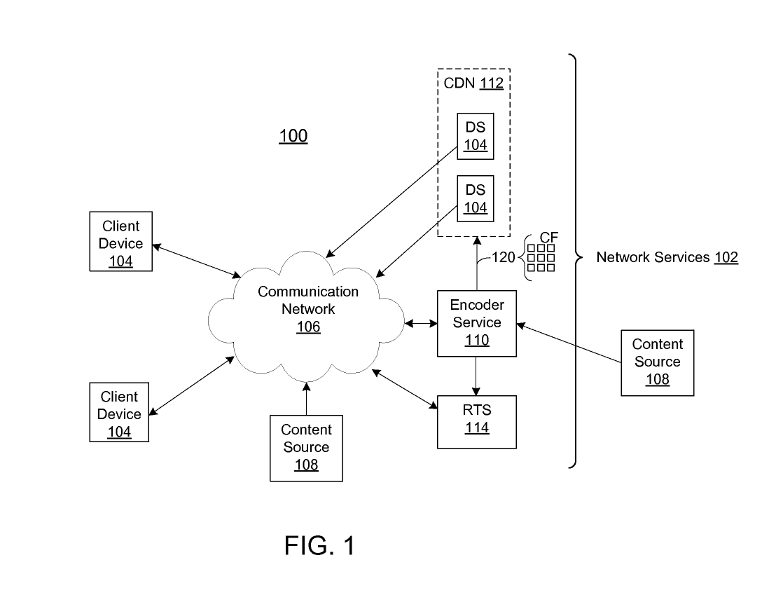

FIG. 1 is a block diagram of an example network environment 100 in which embodiments directed to controlling multimedia content streaming through enhanced client-server interactions may be implemented. Environment 100 supports different adaptive bitrate streaming embodiments, including on-demand streaming, live streaming, and real-time streaming embodiments.

On-demand streaming includes encoding the content of a program from start to end in its entirety and then, after the entire program has been encoded, streaming, i.e., downloading, the encoded program to a client device. An example of on-demand streaming includes streaming a movie from a Video-on-Demand (VOD) service to a client device.

Live streaming includes encoding successive blocks of live content, i.e., a live program, as they are received from a content source, and then streaming each encoded block as it becomes available for download. Live streaming alternates between encoding of content blocks and streaming or downloading of the encoded blocks. Therefore, over a given time period, live streaming includes concurrently encoding content and downloading the encoded content. Often in live streaming the program to be streamed does not have a determinate end, such as in streaming live scenes, i.e., video, captured with a video camera.

Real-time streaming is similar in most aspects to live streaming, except that the input to real-time streaming is not a live video feed. Rather, the input, or source, may include successive encoded blocks, or input blocks, that have a format not suitable for streaming (e.g., for a given system) and must, therefore, be decoded and re-encoded (i.e., transcoded) into an encoded format that is suitable for streaming (in the given system). Real-time streaming handles the successive incompatible input blocks similar to the way live streaming handles the successive blocks of live content. Accordingly, real-time streaming includes transcoding the successive input blocks into transcoded blocks, and then streaming each transcoded block as it becomes available for download. Real-time streaming alternates between the transcoding of input blocks and the streaming or downloading of the transcoded blocks, which are encoded in the suitable format.

Network environment 100 includes a collection of server-side or network services 102 (also referred to simply as “services 102”) and client-side devices 104 (also referred to, collectively, as “client devices 104” and, individually, as a “client device 104”). Network services 102 may be implemented as Internet cloud-based services. Network services 102 interact and cooperate with each other, and with client devices 104, to manage and distribute, e.g., stream, multimedia content from content sources 108 to the client devices, over one or more communication network 106, such as the Internet. Network services 102 communicate with each other and with client devices 104 using any suitable communication protocol, such as an Internet protocol, which may include Transmission Control Protocol/Internet Protocol (TCP/IP), Hypertext Transfer Protocol (HTTP), etc., and other non-limiting protocols described herein.

Each client device 104 may be capable of wireless and/or wired communication with networks 106, and includes processing, storage, communication, and user interface capabilities sufficient to provide all of the client device functionality described herein. Such functionality may be provided, at least in part, by one or more applications, such as computer programs, that execute on client device 104. Applications executed on client device 104 may include a client-side application, which presents Graphical User Interfaces (GUIs) through which a user of the client device may interact with and request services from corresponding server-side applications hosted in services 102. Accordingly, under user control, client device 104 may request/select programs from services 102, stream the selected programs from the services, and then present the streamed programs, in other words, playback the streamed programs.

Content sources 108 may include any number of multimedia content sources or providers that originate live and/or pre-recorded multimedia content (also referred to herein simply as “content”), and provide the content to services 102, directly, or indirectly through communication network 106. Content sources 108, such as Netflix®, HBO®, cable and television networks, and so on, may provide their content in the form of programs, including, but not limited to, entertainment programs (e.g., television shows, movies, cartoons, news programs, etc.), educational programs (e.g., classroom video, adult education video, learning programs, etc.), and advertising programs (e.g., commercials, infomercials, or marketing content). Content sources 108, such as, e.g., video cameras, may capture live scenes provide the resulting real-time video to services 102. Content sources may also include live broadcast feeds deployed using protocols such as Real-time Transport Protocol (RTP), and Real-time Messaging Protocol (RTMP).

Network services 102 include, but are not limited to: an encoder service 110 (also referred to as “encoder 110”) to encode content from content sources 108; a content delivery network (CDN) 112 (also referred to as a “download server 112”) to store the encoded content, and from which the stored, encoded content may be streamed or downloaded to client devices 104; and a real-time service (RTS) 114 (also referred to as a “real-time server (RTS) 114”) to (i) control services 102, and (ii) implement an RTS streaming control interface through which client devices 104 may initiate and then monitor both on-demand, live, and real-time streaming sessions. As will be described more fully below, the RTS streaming control interface advantageously provides useful information regarding the stored encoded files, such as encoding parameters and file properties, to client devices 104 during streaming sessions, so that the client devices may better manage their respective streaming sessions. Each of services 102 may be implemented as one or more distinct computer servers that execute one or more associated server-side computer program applications suited to the given service.

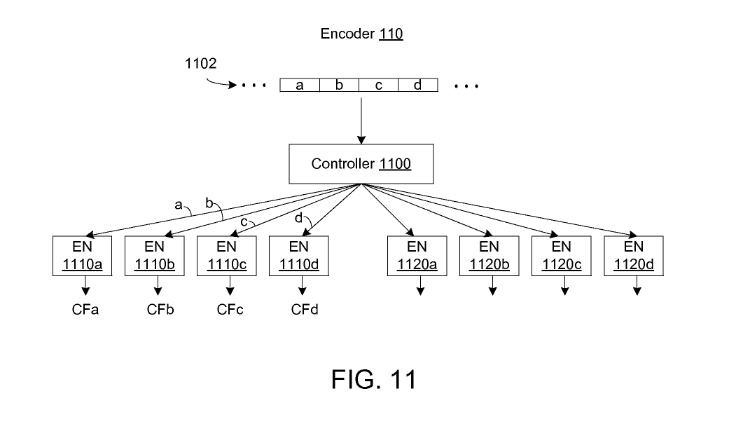

Encoder 110 may be implemented as a cloud encoder accessible over communication network 106. Encoder 110 encodes content provided thereto into a number of alternative bitstreams 120 (also referred to as encoded content) to support adaptive bitrate streaming of the content. For increased efficiency, encoder 110 may be implemented as a parallel encoder that includes multiple parallel encoders, as will be described further in connection with FIG. 11. In such an embodiment, encoder 110 divides the content into successive blocks or clips each of a limited duration in time. Each block may include a number of successive pictures, referred to collectively as a group of pictures (GOPs). Encoder 110 encodes the divided blocks or GOPs in parallel to produce alternative bitstreams 120. Encoders 110 also include transcoders to transcode input files from one encoded format to another, as necessary for the embodiments described herein.

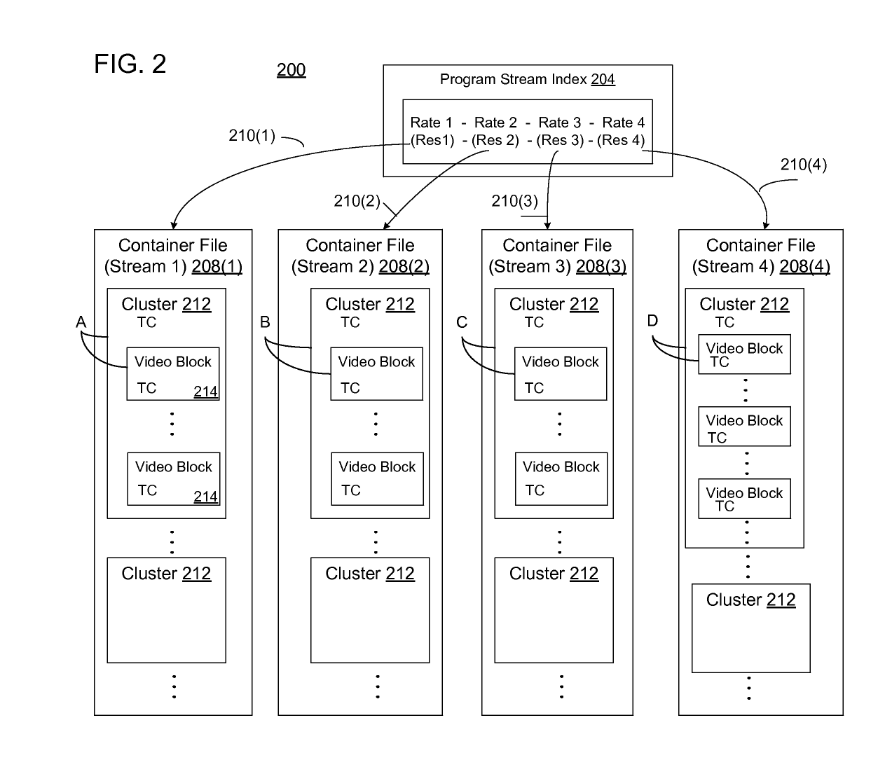

Alternative bitstreams 120 encode the same content in accordance with different encoding parameters/settings, such as at different encoding bitrates, resolutions, and/or frame rates, and so on. In an embodiment, each of bitstreams 120 comprises a large number of sequential (i.e., time-ordered) files of encoded content, referred to herein as container files (CFs), as will be described further in connection with FIG. 2.

After encoder 110 has finished encoding content, e.g., after each of the content blocks is encoded, the encoder uploads the encoded content to CDN 112 for storage therein, and then provides information to RTS 114 identifying the uploaded, encoded content in the form of container files. As will be described more fully below, such identifying information may include network addresses in CDN 112 where client devices 104 may access the encoded content and the encoding parameters used to encode the content.

CDN 112 includes one or more download servers (DSs) 124 to store the uploaded container files at corresponding network addresses, so as to be accessible to client devices 104 through communication network 106. All of the encoded content, e.g., container files, corresponding to a given content source may be stored in only one of download servers 124. Alternatively, the encoded content may be stored across multiple ones of download servers 124.

CDN 112 may also store auxiliary streams which contain information associated with the encoded content mentioned above. The auxiliary streams are encoded at low bitrates, e.g., at bitrates of 200 kbps or much less. The auxiliary streams may include metadata synchronized in time with and descriptive of main content, e.g., a program, to be streamed. The metadata may include cues indicating or bracketing, e.g., commercial segments, or other non-program segments/content interspersed throughout the program. The auxiliary streams would also be streamed to and handled appropriately at the client device.

RTS 114 acts as a contact/control point in network services 102 for client devices 104, through which the client devices may initiate and then monitor their respective on-demand, live, and real-time streaming sessions. To this end, RTS 114 collects information from services 102 that client devices 104 may use to manage their respective streaming sessions, and provides the collected information to the client devices through the RTS streaming control interface, described in further detail below. For example, RTS 114 collects from encoder 110 and/or CDN 112 information identifying the encoded content, e.g., the container files, stored in the CDN. Such information may include, but is not limited to, network addresses of the container files stored in CDN 112, encoding parameters use to encode the container files, such as their encoding bitrates, and file information, such as file sizes, and file types. RTS 114 provides the collected information to client devices 104 through the RTS streaming control interface, as and when appropriate during streaming sessions, thus enabling the client devices to better manage their respective streaming sessions.

### 2 Container Files—Streaming Sources

As described above, encoder 110 encodes content from content sources 108, and CDN 112 stores the encoded content. To support adaptive bitrate streaming, encoder 110 encodes the source programs at multiple bitrates to produce multiple streams for each source program. While streaming such encoded programs from CDN 112, client device 104 may switch between streams (and thus between encoded bitrates and corresponding streaming rates) according to conditions at the client device.

FIG. 2 is an illustration of an example encoded video program 200 generated by encoder 110. Encoded video program 200 includes multiple (encoded) video streams 1-4 encoded at multiple corresponding bitrates Rate 1-Rate 4. Exemplary, non-limiting, bitrates may range from below 125 kilo-bits-per-second (kbps) up to 15,000 kbps, or even higher, depending on the type of encoded media (i.e., content). Encoded video streams 1-4 encode video at multiple video resolutions Res 1-Res 4, which may be equal to or different from each other. Encoded video program 200 includes a program stream index 204 and multiple container files 208(1)-208(4) corresponding to streams 1-4, respectively.

Program stream index 204 includes address pointers 210(1)-(4), e.g., Uniform Resource Locators (URLs), to corresponding container files 208(1)-(4), and lists encoding parameters used to encode each of the streams 1-4, including, but not limited to, encoded bitrates Rate 1-Rate 4, encoding resolutions Res 1-Res 4, frame rates, and encoding techniques/standards. Exemplary, non-limiting, bitrates may range from below 125 kilo-bits-per-second (kbps) up to 15,000 kbps, or even higher, depending on the type of encoded media.

In an embodiment, each of container files 208 comprises sequential clusters 212 of a larger media sector (not shown in FIG. 2), and sequential blocks 214 of encoded media (which may also include audio, text, multimedia, etc., in addition to video) within each of the clusters. Each of container files 208 also includes a container index including address pointers to individual ones of clusters 212 in the container file. Each cluster 212, and each block 214, includes a time code TC indicating a start time for the media encoded in the blocks of that cluster, and encodes a fixed duration of media. For example, each cluster 212 of container file 208(1) encodes two seconds of video. In other embodiments, the time code TC may include both a start time and an end time for the media encoded in the block, and each cluster may encode a different duration of media, which may vary from two seconds. Each cluster 212 is a self-contained unit of media that may be decoded and presented on client devices 204 without reference to any other clusters. Clusters 212 may also include successive cluster numbers identifying a streaming sequence of the clusters.

Although each of container files 208 depicted in FIG. 2 includes multiple clusters/blocks 212/214, other simpler container structures are possible. For example, each container file may include only a single cluster/block of encoded media, such as a two second block, to thereby form a small container file suitable for streaming embodiments described herein. In such an embodiment, many smaller container files collectively encode an equivalent amount of content as a single larger container file.

Each cluster/block 212/214 in a given one of container files 208 may encode the same content (e.g., video content) as corresponding clusters in the other ones of the container files. For example, the cluster/block indicated at A in container file 208(1) has encoded therein the same video as that encoded in the clusters/blocks indicated at B, C, and D of container files 208(2), 208(3), and 208(4), respectively. Corresponding clusters/blocks are also referred to herein as “co-located” clusters/blocks because they encode the same video and share the same time code TC, i.e., they are aligned or coincide in time.

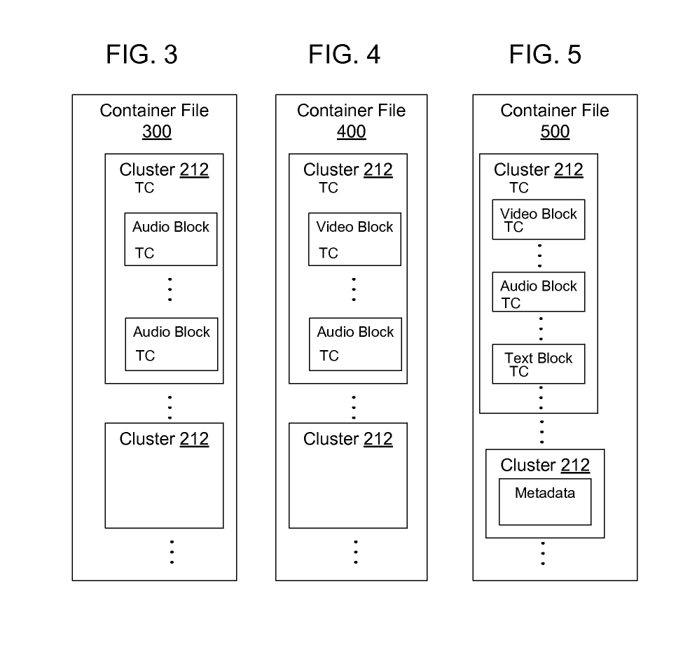

Container files may encode a single stream, such as a video stream (as depicted in FIG. 2), an audio stream, or a text stream (e.g., subtitles). Alternatively, each container file may encode multiple multiplexed streams, such as a mix of video, audio, and text streams. FIGS. 3-5 are further illustrations of diverse container files.

FIG. 3 is an illustration of a container file 300 that encodes a single audio stream.

FIG. 4 is an illustration of a container file 400 that encodes multiplexed audio and video streams.

FIG. 5 is an illustration of a container file 500 that encodes multiplexed video, audio, text, and metadata streams.

In addition, a container file may encode only a metadata stream at a relatively low bitrate.

The encoded container files depicted in FIGS. 2-5 support adaptive streaming to client device 104. If conditions at client device 104 change while streaming, then the client device may switch between container files to stream at encoding bitrates best suited to the conditions.

In embodiments: the container files may be Matroska (MKV) containers based on Extensible Binary Meta Language (EBML), which is a derivative of Extensible Binary Meta Language (XML), or files encoded in accordance with the Moving Picture Experts Group (MPEG) standard; the program index may be provided in a Synchronized Multimedia Integration Language (SMIL) format; and client device 104 may download container files from CDN 114 over networks 106 using the HTTP protocol.

The container files described above may support adaptive streaming of encoded video programs across an available spectrum bandwidth that is divided into multiple, i.e., n, levels. Video having a predetermined video resolution for each level may be encoded at a bitrate corresponding to the bandwidth associated with the given level. For example, in DivX® Plus Streaming, by Rovi Corporation, the starting bandwidth is 125 kbps and the ending bandwidth is 8400 kbps, and the number n of bandwidth levels is eleven (11). Each bandwidth level encodes a corresponding video stream, where the maximum encoded bitrate of the video stream (according to a hypothetical reference decoder model of the video coding standard H.264) is set equal to the bandwidth/bitrate of the given level. In DivX® Plus Streaming, the 11 levels are encoded according to 4 different video resolution levels, in the following way: mobile (2 levels), standard definition (4 levels), 720p (2 levels), and 1080p (3 levels).

### 3 Sequence Diagrams

### 3.1 Start-Up Sequence

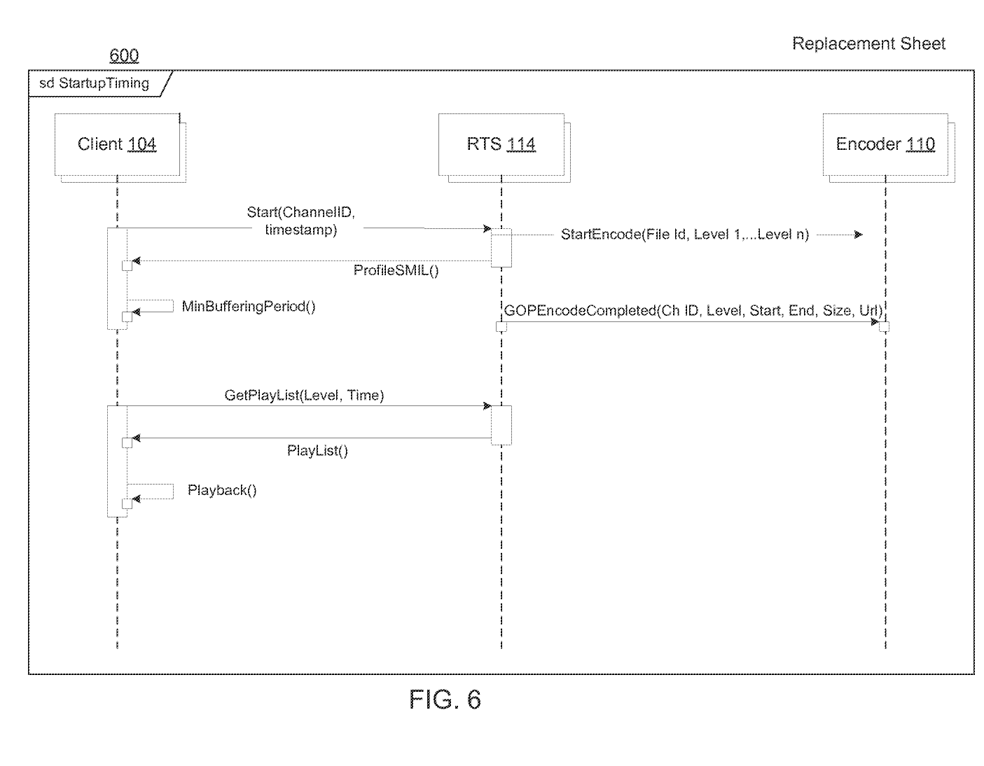

FIG. 6 is a sequence diagram of example high-level interactions 600 between network services 102 and client device 104 used to initiate or start-up streaming in the live and real-time streaming embodiments. Interactions 600 progress in time from top-to-bottom in FIG. 6, and are now described in that order. Interactions between client device 104, encoder 110, and RTS 114 are in accordance with a messaging protocol associated with the RTS streaming control interface. Client device 104 and RTS 114 implement client-side and server-side portions of the messaging protocol.

First, client device 104 sends a “Start” message (also referred to as a “begin playback” message) to RTS 114 to start a streaming session. The Start message includes a channel identifier (ID) and a current time stamp. The channel ID identifies content from a content source that is to be streamed to client 104, and may indicate, e.g., a channel from which the content is to be streamed. Also, the channel ID may include a file ID or other identifier of the content to be streamed or of the content source originating the content to be streamed. The current time stamp (also referred to as “current time”) indicates a current time, such as a Universal Time Code (UTC). The UTC may be acquired from any available UTC time service, as would be appreciated by those or ordinary skill in the relevant arts. In the real-time streaming embodiment, in response to the Start message, RTS 114 sends a “StartEncode” message (also referred to as a “begin encoding” message) to encoder 110 to initiate transcoding of the content identified in the Start message. The StartEncode message includes the FileID to identify the content to be transcoded, and specifies different encoding levels (i.e., encoding bitrates and resolutions) at which the identified content is to be transcode (i.e., converted to another encoding format suitable for streaming). In response to the StartEncode message, encoder 110 begins transcoding the identified content. For example, the FileID may identify a file in an MPEG-4 (MP4) format. The transcoding may then convert the MP4 file to an MKV file. Because transcoding involves encoding, transcoding is also referred to herein, more generally, as “encoding.”

Also in response to the Start message, RTS 114 sends an encoding profile message (referred to as a “ProfileSMIL” message) to client 104. The ProfileSMIL message lists different encoding profiles that will be used by encoder 110 to encode the identified content. Each of the profiles specifies encoding parameters/settings, including, but not limited to: content type (e.g., audio, video, or subtitle); an encoding level corresponding to an encoding bitrate and resolution; and a container file type, e.g., a Multipurpose Internet Mail Extensions (MIME) type.

In response to the StartEncode message, encoder 110 divides the identified content as it is received from a content source into successive or time-ordered blocks or clips, encodes each block into a container file, uploads the container file to CDN 112, and sends a “GOPEncodeCompleted” message to RTS 114 to indicate that the given container file has been uploaded. The GOPEncodeCompleted message includes information identifying the container file that was uploaded, including the content identifier (file ID) to which it relates, the encoding level (i.e., encoding bitrate and resolution), a time code (including, e.g., a start time and an end time) associated with the content block that was encoded into the container file, a file size, and an address of the uploaded file in CDN 112.

After client device 104 receives the ProfileSMIL message, the client device waits a delay period (referred to as the “MinBufferingPeriod” in FIG. 6), and then sends a GetPlaylist message to RTS 114 to request a list of any new container files that have been uploaded since the client device last downloaded (i.e., streamed) and buffered container files (if any) from CDN 112. The GetPlaylist message includes selection criteria for uploaded container files, namely, a current time and an encoding level. The current time represents a time code associated with the last container file downloaded by client device 104 (if any) in the current streaming session. The encoding level specifies the encoding bitrate (and the resolution, for encoded video) of container files that client device 104 has determined it will accept for purposes of streaming from CDN 112.

In response to the GetPlaylist message, RTS 114:
a. selects the uploaded container files, as identified to the RTS in the GOPEncodeCompleted messages, that meet the criteria specified in the GetPlaylist message. The selected, uploaded container files are those container files that have (i) a time code greater than the current time, and (ii) an encoding bitrate and resolution that corresponds to the specified level (i.e., the specified encoding bitrate and resolution);
b. generates a playlist message (referred to as a PlaylistSMIL message) identifying the selected container files; and
c. sends the PlaylistSMIL message to client device 104.

For each of the selected container files, the PlaylistSMIL message includes the following information: the type of content encoded in the container file (e.g., video, audio, or subtitle); an address (e.g., URL) of the container file in CDN 112; a time code, e.g., a start time and an end time, associated with the content block encoded in the container file; and a file size of the container file.

In response to the PlaylistSMIL message, client device 104 accesses the container files at their addresses in CDN 112 as identified in the PlaylistSMIL message, and downloads the accessed container files from the CDN. Client device 104 buffers and decodes the downloaded container files to recover the content encoded therein, and then presents the recovered content, whether audio, visual, or in other form. This sequence is referred to as “Playback” at the end of sequence diagram 600.

### 3.2 Playback Sequence

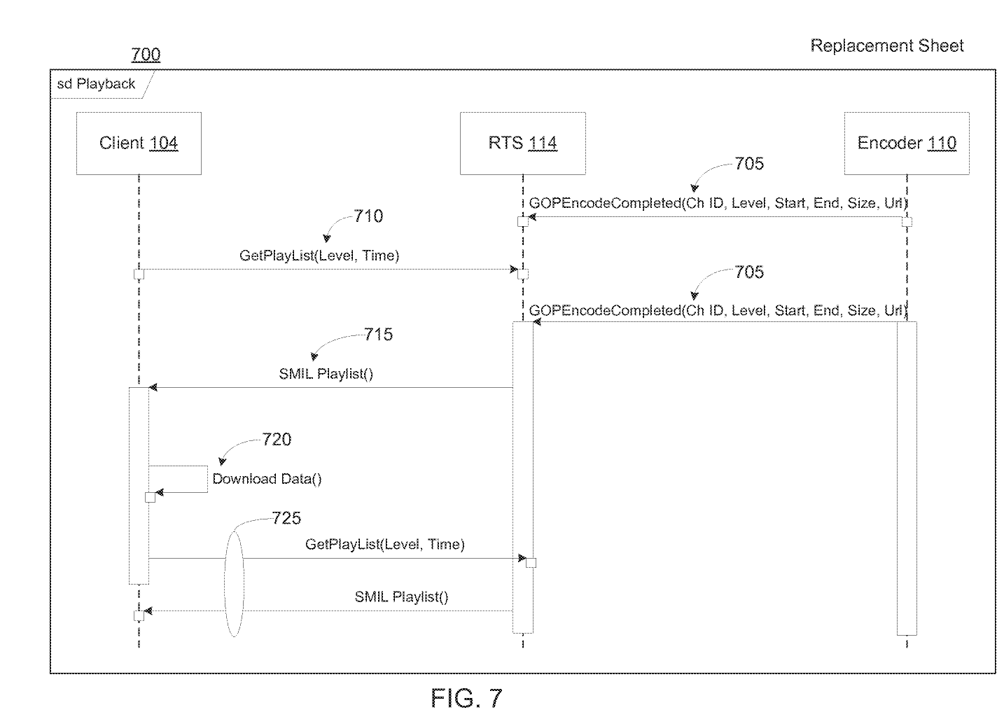

FIG. 7 is a sequence diagram of example high-level interactions 700 between network services 102 and client device 104 used to playback content in the streaming embodiments, once a streaming session has been initiated. Interactions between client device 104, encoder 110, and RTS 114 are in accordance with the messaging protocol associated with the RTS streaming control interface.

At 705, each time encoder 110 encodes blocks of content into container files and uploads the container files to CDN 112, the encoder notifies or updates RTS 114 with GOPEncodeCompleted messages identifying the recently uploaded files.

At 710, client device 104 sends to RTS 114 a GetPlaylist message including the current time and encoding level selection criteria.

In response to the GetPlaylist message, at 715, RTS 114 generates a PlaylistSMIL message based on the selection criteria, i.e., current time and specified encoding level, in the GetPlaylist message and the container file information provided from encoder 110 in the GOPEncodeCompleted messages, and provides the generated PlaylistSMIL to client device 104. As mentioned above in connection with FIG. 6, the PlaylistSMIL message identifies container files uploaded to CDN 112 having their content encoded at the specified encoding level and associated with time codes greater than the current time.

In response to the PlaylistSMIL message, at 720, client device 104 accesses the container files at their addresses in CDN 112 as identified in the PlaylistSMIL, and downloads the accessed container files from the CDN. This is referred to as “Download” in sequence diagram 700. Client device 104 buffers and decodes the downloaded container files to recover the content encoded therein, and then presents the recovered content.

At 725 the sequence 705-720 repeats.

In summary, in playback sequence 700, client device 104 periodically downloads an updated PlaylistSMIL message and continues playback (i.e. continues to download the container files indicated in the PlaylistSMIL message), while RTS 114 creates a new PlaylistSMIL message by accumulating all container files that have a time code, e.g., a begin time, greater than the current time indicated in the GetPlaylist message.

### 3.3 End of Stream Sequence

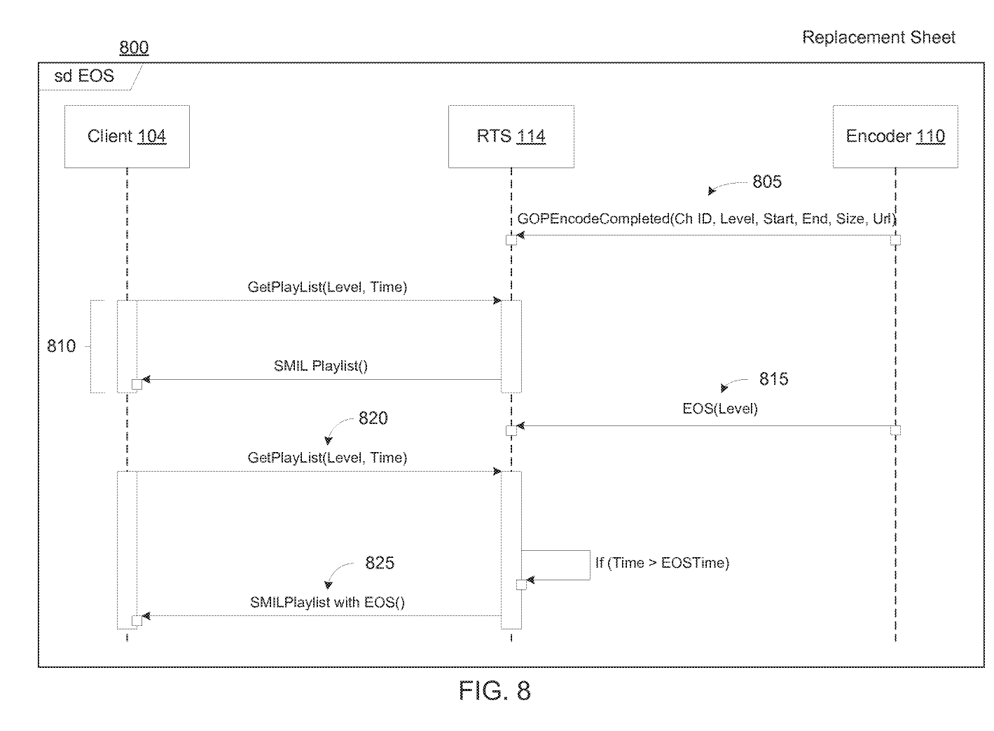

FIG. 8 is a sequence diagram of example high-level interactions 800 between network services 102 and client device 104 used to indicate an end of the content to be streamed in streaming embodiments described herein. Interactions between client device 104, encoder 110, and RTS 114 are in accordance with the messaging protocol associated with the RTS streaming control interface.

At 805, when encoder 110 has encoded a last block of the content to be encoded into a last container file and uploaded the last container file to CDN 112, the encoder sends a last GOPEncodeCompleted message to RTS 114 identifying the last uploaded container file to the RTS.

At 810, RTS 114 and client 104 exchange GetPlaylist and PlaylistSMIL messages.

At 815, encoder 110 sends an End of Stream (EOS) message to RTS 114 indicating that the last container file was uploaded, and including an EOS time indicating a last time code of the uploaded container files.

At 820, client 104 sends a GetPlaylist message to RTS 114.

At 825, RTS 114 sends a PlaylistSMIL with an EOS indicator to client device 104, if the current time is greater than the EOS time.

### 4 Message Definitions

### 4.1 ProfileSMIL and PlaylistSMIL Message Definitions

### 4.1.1 ProfileSMIL

In an embodiment, the ProfileSMIL message structure is in accordance with the World Wide Web Consortium (W3C) recommended Extensible Markup Language (XML) markup language, Synchronized Multimedia Integration Language (SMIL) 3.0 Tiny profile. This profile is well-suited to descriptions of web-based multimedia. However, other protocols may be used to structure the ProfileSMIL message.

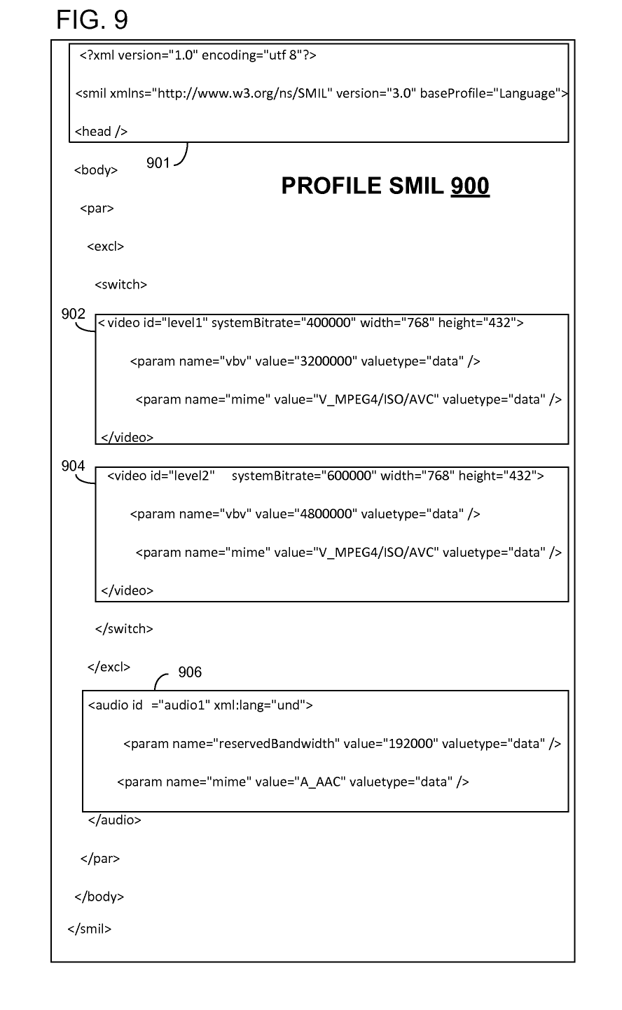

FIG. 9 is an example ProfileSMIL message 900. ProfileSMIL 900 includes a header 901 to specify the base profile as SMIL 3.0 (Tiny), and a body including video encoding (VE) profiles 902 and 904, and an audio encoding (AE) profile 906.

Each of VE profiles 902 and 904 specifies the following encoding settings or parameters:
a. a content type, e.g., video;
b. an encoding level (e.g., level 1 or level 2) and corresponding encoding bitrate (e.g., bitrate=400000 bps or 6000000 bps) and video resolution in pixel width and height dimensions (e.g., 768×432);
c. a variable bit rate verifier (vbv) (e.g., 3200000 or 4800000); and
d. a MIME type.

Similarly, AE profile 906 specifies:
a. a content type, e.g., audio;
b. a reserved bandwidth value (e.g., 192000); and
c. a MIME type.

### 4.1.2 PlaylistSMIL

### 4.1.2.1 Structure

Like the ProfileSMIL message, the PlaylistSMIL message structure is in accordance with SMIL 3.0. In other words, the base profile of the SMIL message is Tiny, as is indicated in the ProfileSMIL message header (see the box below).

<?xml version=“1.0” encoding=“utf-8”?>
<smil xmlns=“http://www.w.org/ns/SMIL”
version=“3.0” baseProfile=“Tiny”>
</smil>

### 4.1.2.2 Seq Element

The PlaylistSMIL message includes sequential elements, each of which is defined as a seq element <seq>. In an embodiment, each seq element corresponds to an uploaded container file. Using seq elements, RTS 114 is able to specify a sequence of real-time media streams for playback. A sequence tag is used with each element to indicate one of <video>, <audio> or <subtitle/text> encoded content for streaming, as depicted in the following two boxes.

Description

| Element | Element | Description |
|---|---|---|
| Seq | Video | Video only mkv file. |
| | Audio | Audio only mkv file. |
| | Textstream | Subtitle only mkv file. |

### Example

```
<seq>
    <video
src=“http://cnd.com/video_test1_300kbps.mkv”/>
    <video
src=“http://cnd.com/video_test2_300kbps.mkv”/>
    <video
src=“http://cnd.com/video_test3_300kbps.mkv”/>
</seq>
```

In the second “Example” box above, the source “src” variables specify URLs of associated elements (e.g., container files).

### 4.1.2.3 MediaSize Parameter

The PlaylistSMIL message specifies a file size or “mediaSize” for each <video>, <audio> and <textstream> element (e.g., container file).

| Params | Description |
|---|---|
| mediaSize | The file size of the media sample. |

### Example

```
<video
    src=“http://cnd.com/video1_620kbps.mkv”
    systemBitrate=“620”
    width=“480”
    height=“270” >
    <param
        name=“mediaSize”
        value=“1000”
        valuetype=“data” />
</video>
```

### 4.1.2.4 ClipBegin and ClipEnd Attribute (Time Code)

In the PlaylistSMIL message, the following additional attributes are defined for all media elements—ClipBegin and ClipEnd, which represent a time code, comprising a start time and an end time of the content segment encoded into the associated element (e.g., container file).

### Example

<seq>
<video src=”http://cnd.com/video1_400kbps.mkv”
ClipBegin=”SS” ClipEnd = “SS”>
</seq>

### 4.1.2.5 Example PlaylistSMIL

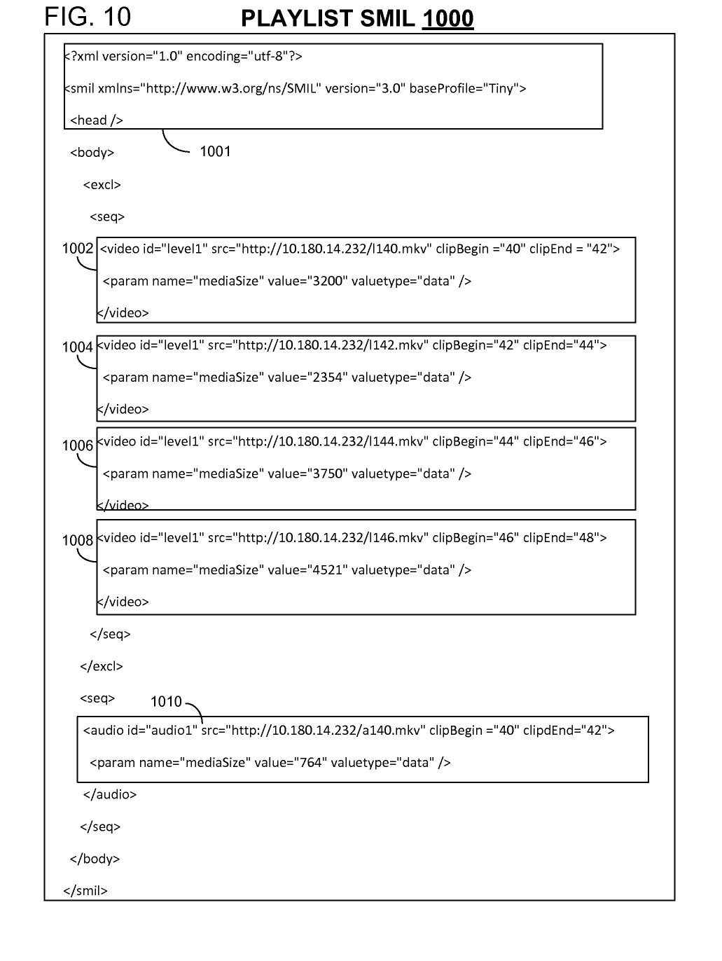

FIG. 10 is an example PlaylistSMIL message 1000 generated in response to a GetPlaylist message selection criteria including a current time of 40 (seconds) and specifying a level 1 encoding bitrate. PlaylistSMIL message 1000 includes a header 1001 to specify the base profile as SMIL 3.0, and a body that includes records 1002-1010 identifying respective uploaded elements (e.g., container files) that meet the PlaylistSMIL message criteria. Records 1002-1008 identify three container files containing successive or time-ordered two second blocks of encoded video. Record 1010 identifies a container file containing a two second segment of encoded audio. Each of the PlaylistSMIL message records 1002-1010 includes:
a. a content type identifier (e.g., video or audio);
b. a URL of the identified container file (e.g., src=http://10.180.14.232/1140.mkv);
c. a time code in seconds (e.g., a start time and an end time, referred to as “ClipBegin” and “ClipEnd,” respectively) associated with the segment encoded in the identified container file. The time codes for each of the container files are 40-42, 42-44, and 46-48); and
d. a file size of the identified container file (e.g., 3200 kilobits).

### 4.2 Real-Time Server RESTful/HTTP Message Interface for Start, StartEncode, GetPlaylist, GOPEncodeCompleted, and EOS Messages

### 4.2.1 Overview

A web service implemented using HTTP and the principles of a stateless Representational State Transfer (REST) is known as a RESTful web service. RTS 114 uses a RESTful web service to implement the Start (also referred to as “begin playblack”), StartEncode (also referred to as “begin encode”), GetPlaylist (also referred to as “Playlist request” or “request Playlist”), GOPEncodeCompleted, and EOS messages.

As mentioned above, through RTS 114, environment 100 supports on-demand, live and real-time streaming embodiments. This leads to the following three streaming scenarios:
a. On-demand streaming: wherein content identified by a Channel Id has already been encoded and is available for on-demand downloading. In this scenario, RTS 114 assembles a PlaylistSMIL each time client device 104 places a Playlist request (i.e., sends a GetPlaylist message to the RTS).
b. Real-time streaming (1): wherein content identified by a Channel Id has an encoding session underway to transcode files into an appropriate encoded format, e.g., into an MKV format. RTS 114 operates in accordance with sequence diagrams 700 and 800 discussed above in connection with FIGS. 7 and 8, respectively, i.e., the RTS assembles a PlaylistSMIL message each time client device 104 places a Playlist request (i.e., sends a GetPlaylist message to the RTS).
c. Live streaming (2): wherein content identified by a Channel Id has a live streaming session through a RTP or RTMP feed. Subsequent Playlist requests (i.e., GetPlaylist messages) are handled in a manner similar to that in scenarios a and b.

### 4.2.2 Start (Begin Playback)

The Start message follows the syntax indicated in the example Start message below:

POST /initplayback HTTP/1.1
Content-type: application/xml
<?xml version=”1.0”?>
<File>
<ChannelId>123</ChannelId></File>

### 4.2.3 StartEncode (Begin Encode)

The StartEncode message follows the syntax indicated in the following example message:

POST /beginencode HTTP/1.1
Content-type: application/xml
<?xml version=”1.0”?>
<Encode>
<Id> 123457 <Id>
<Url>/mnt/ydrive/TheArrival.yuv</Url>
<minLevel>1</minLevel>
<maxLevel>2</maxLevel>
</Encode>

In response to the StartEncode message, RTS 114 determines the following conditions:
a. whether an encoding session for the content identified by the File Id is underway; and
b. whether that content has been encoded prior to the StartEncode message.

If either one of the conditions is determine to be true, then RTS 114 does not send the StartEncode message to the cloud server; But, if both of these conditions fail, then RTS 114 POSTS the StartEncode message with the File Id and its accompanying URL.

### 4.2.4 GetPlaylist (Request Playlist)

The GetPlaylist message follows the syntax in the following example message:

GET/Playlist?FileID=1234567&LastSegmentDownload=time&Level=level
HTTP/1.1

Upon receiving this request, RTS 114 responds with the PlaylistSMIL message. The following rules apply:
a. The RTS generates a PlaylistSMIL message that contains container files uploaded since the “time” (also referred to herein as the “current time”) indicated in the message, which may be in seconds;
b. The RTS generates a PlaylistSMIL message only for the level (corresponding to an encoding bitrate and resolution) indicated in the message; and
c. The RTS may return a predetermined maximum number, e.g., ten, of encoded container files; such a restriction prevents the PlaylistSMIL from identifying an overly large amount of encoded content.

### 4.2.5 GOPEncodeCompleted

The GOPEncodeCompleted message follows the syntax in the following example message:

POST /gopencodecompleted HTTP/1.1
Content-type:application/xml
<?xml version=”1.0”>
<GOP>
<Type>video</Type>
<ChannelID>ID<ChannelID>
<Level>level</level>
<ClipBegin>SS</ClipBegin>
<ClipEnd>SS</ClipEnd>
<FileSize>Size in KB </FileSize>
<Url>url</Url>
</GOP>

4.2.6 EOS message

The EOS message follows the syntax in the following example message:

POST /eos HTTP /1.1
Content-type: application/xml
<?xml version=”1.0”>
<EOS>
<Level>level</Level>
</EOS>

The EOS message is transmitted from cloud encoder 110 to the RTS 114; Upon receiving the EOS message, RTS 114 inserts the EOS message into a SMILPlaylist message.

### 5 Parallel Encoder

FIG. 11 is a block diagram of encoder 112, according to a parallel encoder embodiment. Encoder 110 includes a controller 1100, a first group of parallel encoders 1110a-d configured to encode in accordance with first encoder parameters/settings, and a second group of parallel encoders 1120a-d configured to encode in accordance with second encoder parameters/settings. Controller 1100 receives a stream of original (unencoded) content 1102 from a content source, and divides the content into successive, or time-ordered, contiguous blocks of content a-d, e.g., GOPs a-d. Controller 1100 routes each of content blocks a-d to a corresponding one of parallel encoders 1110a-d, and a corresponding one of parallel encoders 1120a-d.

Encoders 1110a-d encode their respective content blocks a-d in parallel, i.e., concurrently, at a first encoding rate associated with the first encoding parameters/settings, to produce respective container files CFa-d in parallel. Each of container files CFa-d contains encoded content of the corresponding one of content blocks a-d. Similarly, encoders 1120a-d encode their respective content blocks a-d in parallel with each other and encoders 1110a-d at a second encoding rate associated with the second encoding parameters/settings, to produce respective container files (not specifically enumerated in FIG. 11). Controller 1100 uploads the container files to CDN 112, and provides information identifying the uploaded container files to RTS 114, i.e., the controller notifies the RTS about the upload. Encoder 110 repeats the above-described process for successive groups of content blocks a-d.

Encoder 110 may include more than two groups of parallel encoders, and more or less than four parallel encoders in each group. Also, controller 1100 may divide content stream 1102 into content blocks having durations of more than two seconds or less than two seconds.

### 6 Client Device Streaming

As described herein, during a streaming session, client device 104 repeatedly generates and sends to RTS 114 a GetPlaylist message indicating an encoding level suitable to the client device, and in response, receives a PlaylistSMIL message from the RTS identifying new encoded files corresponding to the indicated encoding level that are available for download. Client device 104 selects among the new encoded files identified in the PlaylistSMIL message and then downloads the selected files for continuing playback.

Client device 104 includes an adaptive streaming determiner module to determine the suitable encoding level requested in the GetPlaylist message, and select among the new encoded files to be downloaded. The adaptive streaming determiner module determines the suitable encoding level and selects which encoded files to download based on a variety of factors and information. The determiner module may determine the suitable level and which encoded files to select for download based on the following non-limiting factors:
a. a communication bandwidth of client device 104 available for downloading content; and
b. information provided by RTS 114 to the client device in the ProfileSMIL and PlaylistSMIL messages regarding the properties of the encoded content that is available for download, including:
   i. the encoding levels associated with the encoded files as indicated in the ProfileSMIL message;
   ii. a size of, and amount of presently downloaded content in, video download buffers of the client device; and
   iii. sizes of, and time codes associated with, the encoded files as identified in the PlaylistSMIL message.

### 7 Method Flowcharts

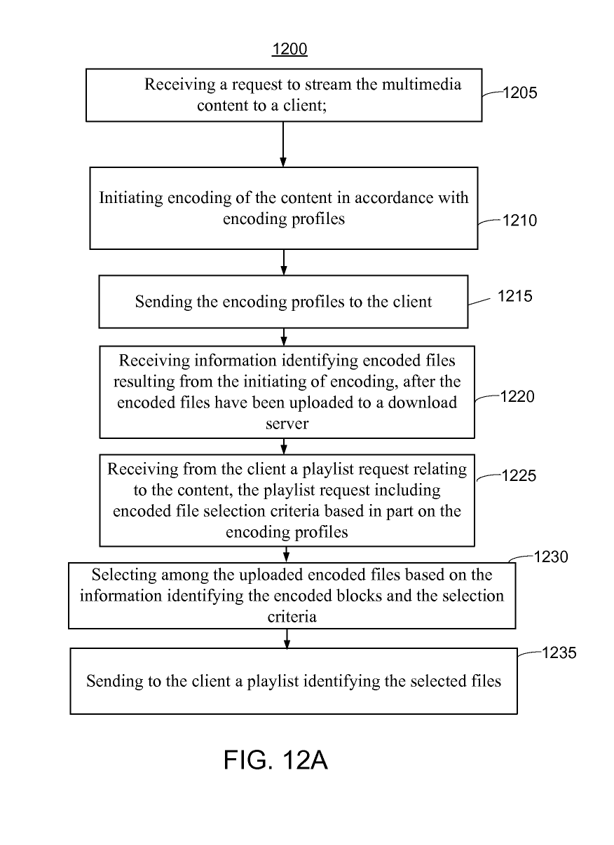

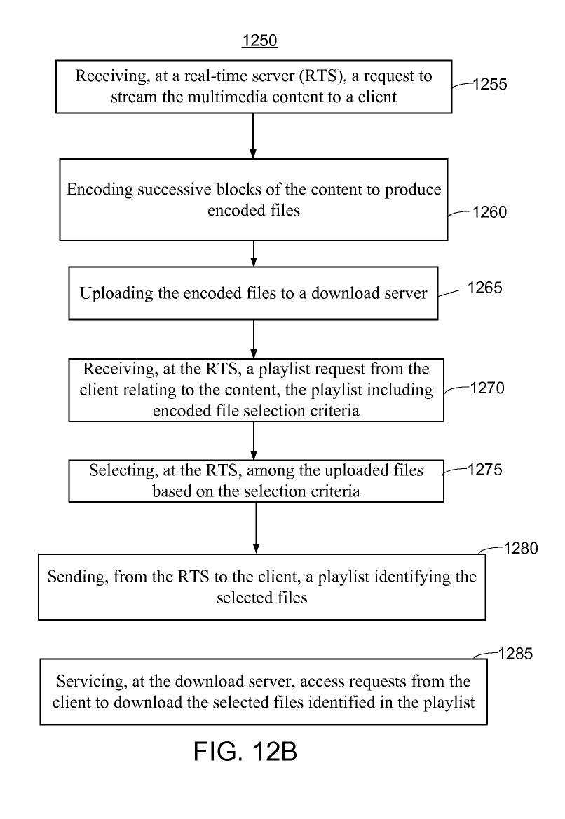

FIG. 12A is a flowchart of an example method 1200 of controlling streaming of multimedia content from network services 102 to client device 104 (referred to as a “client” in method 1200) in environment 100. Method 1200 supports on-demand, live, and real-time streaming. In an embodiment, the operations of method 1200 are implemented in RTS 114. The multimedia content may include video, audio, and text (e.g., subtitles).

1205 includes receiving a request (e.g., a Start message) to stream the multimedia content to a client, i.e., to initiate a streaming session. The streaming session may support real-time streaming.

Only the real-time streaming embodiment includes 1210. 1210 includes initiating encoding of the content (e.g., sending a StartEncode message to an encoder) in accordance with encoding profiles (e.g., encoding levels, each corresponding to an encoding bitrate and resolution).

1215 includes sending the encoding profiles (e.g., sending a ProfileSMIL message) to the client.

1220 includes receiving information identifying encoded files resulting from the initiating of encoding, after the encoded files have been uploaded to a download server (e.g., the encoder sends identifying information to RTS 114). The initiating encoding results in uploaded encoded files that include, at each of multiple encoding bitrates, encoded files having successive time codes.

1225 includes receiving from the client a playlist request (e.g., a GetPlaylist message) relating to the content, the playlist request including encoded file selection criteria based in part on the encoding profiles. In an embodiment, the selection criteria (i) includes a current time, and (ii) specifies an encoding level, corresponding to an encoding bit rate and resolution, that is suitable for the client.

1230 includes selecting among the uploaded encoded files based on the information identifying the encoded files and the selection criteria. In an embodiment, the selecting includes selecting uploaded encode files associated with time codes greater than the current time and that correspond to encoding levels that match the specified encoding level.

1235 includes sending to the client a playlist (e.g., a PlaylistSMIL message) identifying the selected files. The playlist includes, for each identified uploaded encoded file, at least one of an address of the file in the download server, a time code associated with the file, and a size of the file.

Method 1200 further includes repeating over time operations 1215-1235 so as to control streaming of the content throughout the session.

FIG. 12B is a flowchart of an example another method 1250 of controlling streaming of multimedia content from network services 102 to client device 104 in environment 100. The operations of method 1200 are implemented across RTS 114, encoder 110, and CDN 112 (the download server).

1255 includes receiving, at a real-time server (RTS), a request (e.g., a Start message) to stream the multimedia content to the client.

1260 includes encoding successive blocks of the content to produce encoded files. The encoding produces successive encoded files such that they are associated with successive time codes corresponding to time codes of the received content. In an embodiment, the encoding further includes encoding the successive blocks to produce, at each of multiple encoding bitrates, encoded files having successive time codes.

1265 includes uploading the encoded files to a download server. In addition, 1215 includes identifying the uploaded files to the RTS.

1270 includes receiving, at the RTS, a playlist request (e.g., a GetPlaylist message) from the client relating to the content, the playlist including selection criteria.

1275 includes selecting, at the RTS, among the uploaded files based on the selection criteria.

1280 includes sending, from the RTS to the client, a playlist (e.g., a PlaylistSMIL message) identifying the selected files.

1285 includes servicing, at the download server, access requests from the client to download the selected files identified in the playlist.

Method 1200 further includes repeating over time the operations 1210-1235 so as to control streaming of the multimedia content to the client.

Method 1200 also includes sending, from the RTS to the client device, an encoding profile message (e.g., a ProfileSMIL message) indicating the multiple encoding bitrates used in the encoding.

In an embodiment including multiple download servers, method 1250 further includes:
a. at 1265, uploading the encoded files to multiple download servers;
b. at 1275, selecting uploaded encoded files from across the multiple download servers;
c. at 1280, sending a playlist identifying the selected files in the multiple download servers (e.g., the playlist includes addresses to container files stored in different download servers); and
d. at 1285, servicing access requests from the client to download the selected files identified in the playlist from the multiple download servers.

### 8 Systems

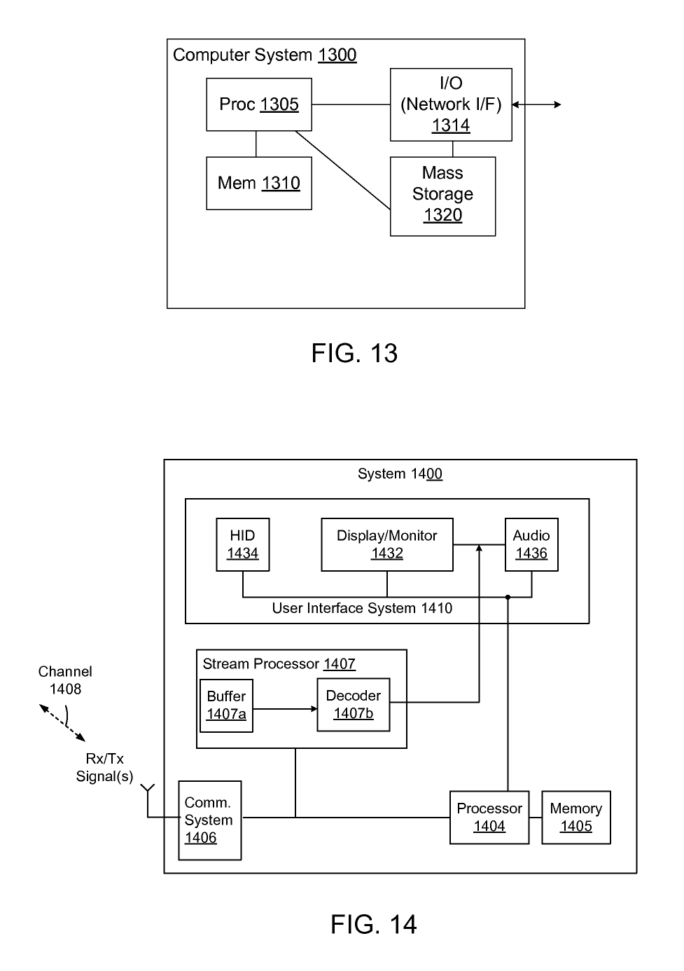

Methods and systems disclosed herein may be implemented with respect to one or more of a variety of systems including one or more consumer systems, such as described below with reference to FIGS. 13 and 14. Methods and systems disclosed herein are not, however, limited to the examples of FIGS. 13 and 14.

FIG. 13 is a block diagram of an example computer system 1300 corresponding to any of network services 102, including encoder 110, CDN 112, and RTS 114. Computer system 1300, which may be, e.g., a server, includes one or more processors 1305, a memory 1310 in which instruction sets and databases for computer program applications are stored, a mass storage 1320 for storing, e.g., encoded programs, and an input/output (I/O) module 1315 through which components of computer system 1300 may communicate with communication network 106.

FIG. 14 is a block diagram of an example system 1400 representing, e.g., client device 104, and may be implemented, and configured to operate, as described in one or more examples herein.

System 1400 or portions thereof may be implemented within one or more integrated circuit dies, and may be implemented as a system-on-a-chip (SoC).

System 1400 may include one or more processors 1404 to execute client-side application programs stored in memory 1405.

System 1400 may include a communication system 1406 to interface between processors 1404 and communication networks, such as networks 106.

Communication system 1406 may include a wired and/or wireless communication system.

System 1400 may include a stream processor 1407 to process program (i.e., content) streams, received over channel 1408 and through communication system 1406, for presentation at system 1400. Stream processor 1407 includes a buffer 1407a to buffer portions of received, streamed programs, and a decoder 1407b to decode and decrypt the buffered programs in accordance with encoding and encryption standards, and using decryption keys. In an alternative embodiment, decoder 1407b may be integrated with a display and graphics platform of system 1400. Stream processor 1407 together with processors 1404 and memory 1405 represent a controller of system 1400. This controller includes modules to perform the functions of one or more examples described herein, such as a streaming module to stream programs through communication system 1406.

System 1400 may include a user interface system 1410.

User interface system 1410 may include a monitor or display 1432 to display information from processor 1404, such as client-side storefront GUIs.

User interface system 1410 may include a human interface device (HID) 1434 to provide user input to processor 1404. HID 1434 may include, for example and without limitation, one or more of a key board, a cursor device, a touch-sensitive device, and or a motion and/or image sensor. HID 1434 may include a physical device and/or a virtual device, such as a monitor-displayed or virtual keyboard.

User interface system 1410 may include an audio system 1436 to receive and/or output audible sound.

System 1400 may correspond to, for example, a computer system, a personal communication device, and/or a television set-top box.

System 1400 may include a housing, and one or more of communication system 1406, processors 1404, memory 1405, user interface system 1410, or portions thereof may be positioned within the housing. The housing may include, without limitation, a rack-mountable housing, a desk-top housing, a lap-top housing, a notebook housing, a net-book housing, a set-top box housing, a portable housing, and/or other conventional electronic housing and/or future-developed housing. For example, communication system 1402 may be implemented to receive a digital television broadcast signal, and system 1400 may include a set-top box housing or a portable housing, such as a mobile telephone housing.

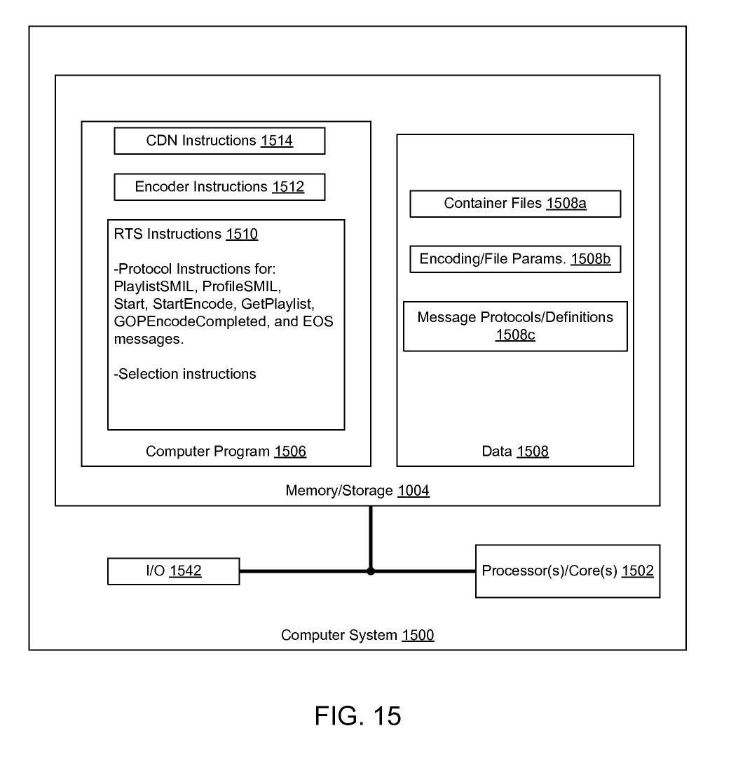

FIG. 15 is a block diagram of a computer system 1500 configured to support/perform on-demand and real-time streaming as described herein.

Computer system 1500 includes one or more computer instruction processing units and/or processor cores, illustrated here as processor 1502, to execute computer readable instructions, also referred to herein as computer program logic.

Computer system 1500 may include memory, cache, registers, and/or storage, illustrated here as memory 1504, which may include a non-transitory computer readable medium encoded with computer programs, illustrated here as computer program 1506.

Memory 1504 may include data 1508 to be used by processor 1502 in executing computer program 1506, and/or generated by processor 1502 during execution of computer program 1506. Data 1508 may include container files 1508a, encoding and file parameters 1508b, and message/protocol definitions 1508c such as used in the methods described herein.

Computer program 1506 may include:

RTS application instructions 1510 to cause processor 1502 to perform RTS functions as described herein, e.g., to implement the RTS streaming control interface comprising, e.g., PlaylistSMIL, ProfileSMIL, Start, StartEncode, GetPlaylist, GOPEncodeCompleted, and EOS messages exchanged between the RTS, encoder, and client device, and to select uploaded encoded files based on an encoded file selection criteria;

encoder instructions 1512 to cause processor 1502 to encode identified content for streaming; and

CDN instructions 1514 to cause processor 1502 to permit access to container files to be downloaded to the client device.

Instructions 1510-1514 cause processor 1502 to perform functions such as described in one or more examples above.

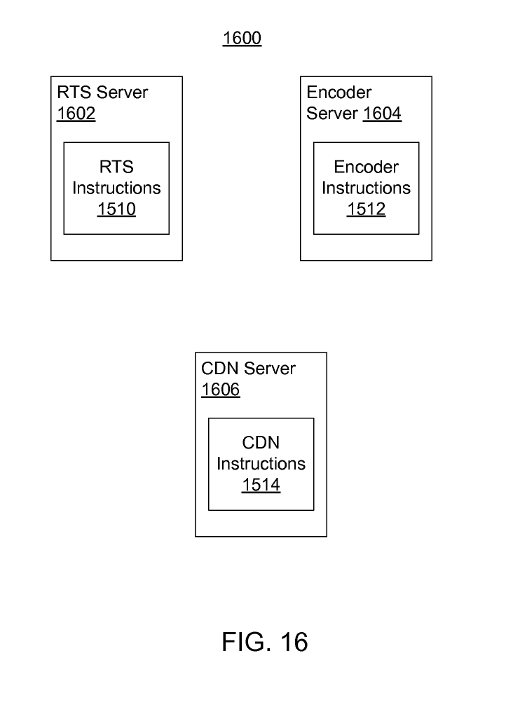

Computer system 1500 is depicted as one system in FIG. 15. However, RTS instructions 1510 and supporting data, encoder instructions 1512 and supporting data, and CDN instructions 1514 and supporting data, may each be hosted in their own distinct computer system/server similar to system 1000, as depicted in FIG. 16.

FIG. 16 is a block diagram of an environment 1600 in which RTS instructions 1510 and supporting data, encoder instructions 1512 and supporting data, and CDN instructions 1514 and supporting data, are each hosted in distinct computer systems 1602, 1604, and 1606, respectively.

Methods and systems disclosed herein may be implemented in circuitry and/or a machine, such as a computer system, and combinations thereof, including discrete and integrated circuitry, application specific integrated circuitry (ASIC), a processor and memory, and/or a computer-readable medium encoded with instructions executable by a processor, and may be implemented as part of a domain-specific integrated circuit package, a system-on-a-chip (SOC), and/or a combination of integrated circuit packages.

Methods and systems are disclosed herein with the aid of functional building blocks illustrating functions, features, and relationships thereof. At least some of the boundaries of these functional building blocks have been arbitrarily defined herein for the convenience of the description. Alternate boundaries may be defined so long as the specified functions and relationships thereof are appropriately performed. While various embodiments are disclosed herein, it should be understood that they are presented as examples. The scope of the claims should not be limited by any of the example embodiments disclosed herein.

What is claimed is:

1. A method of controlling streaming of multimedia content, comprising:
receiving a request to stream the multimedia content to a client;
receiving information identifying encoded files that encode the multimedia content;
receiving from the client a playlist request relating to the content, the playlist request including encoded file selection criteria;
selecting among the encoded files based on the information identifying the encoded blocks and the selection criteria; and
sending a playlist identifying the selected files to the client.

2. The method of claim 1, wherein the multimedia content includes audio, video, and text, and the initiating encoding includes initiating encoding of the audio, video, and text.

3. The method of claim 1, wherein:
the encoded files include encoded files that each encode a corresponding one of successive blocks of content and are associated with successive time codes;
the selection criteria include a current time; and
the selecting includes selecting the encoded files associated with time codes that are greater than the current time.

4. The method of claim 3, wherein:
the encoded files further include, at each of multiple encoding bitrates, encoded files having successive time codes;
the selection criteria specifies an encoding bitrate of one of the encoding profiles; and
the selecting further includes selecting the encoded files associated with an encoding bitrate that matches the specified encoding bitrate.

5. The method of claim 1, wherein the playlist includes, for each identified file:
an address where the identified file is stored;
a time code associated with the identified file; and
a size of the identified file.

6. The method of claim 1, wherein:
the encoded files contain corresponding content encoded in accordance with encoding profiles including encoding parameters;
the method further comprises sending the encoding profiles to the client; and
the encoded file selection criteria are based in part on the encoding profiles.

7. The method of claim 6, wherein:
the encoding profiles include encoding levels each specifying an encoding bitrate and a corresponding resolution;
the encoded file selection criteria specifies at least one of the encoding levels; and
the selecting includes selecting the encoded files that match the specified at least one of the encoding levels.

8. The method of claim 1, further comprising:
encoding successive blocks of content to produce corresponding encoded files; and
storing the encoded files.

9. The method of claim 8, wherein:
the encoding further includes encoding the successive blocks to produce, at each of multiple encoding bitrates, encoded files having successive time codes;
the encoded file selection criteria specify an encoding bitrate; and
the selecting further includes selecting the encoded files associated with an encoding bitrate that matches the specified encoding bitrate.

10. The method of claim 1, further comprising: repeating over time the receiving information identifying encoded files, the receiving a playlist request, the selecting, and the sending a playlist so as to control streaming of the multimedia content to the client.

11. The method of claim 1, further comprising, servicing, at a download server in which the encoded files are stored, access requests from the client to download the selected files identified in the playlist.

12. The method of claim 11, wherein:
the information identifying the encoded files indicates that the encoded files have been stored across multiple download servers;
the selecting includes selecting encoded files stored across the multiple download servers; and
the sending includes sending a playlist identifying the selected files in the multiple download servers.

13. A system to control streaming of multimedia content, comprising:
a real-time server (RTS), including one or more processors and memory, to:
receive a request to stream the multimedia content to a client;
receive information identifying encoded files that encode the multimedia content;
receive from the client a playlist request relating to the content, the playlist request including encoded file selection criteria;
select among the encoded files based on the information identifying the stored encoded blocks and the selection criteria; and
send to the client a playlist identifying the selected files.

14. The system of claim 13, wherein the multimedia content includes audio, video, and text.

15. The system of claim 13, wherein:
the encoded files include encoded files that each encode a corresponding one of successive blocks of content and are associated with successive time codes;
the selection criteria include a current time; and
the RTS is further configured to select the encoded files associated with time codes that are greater than the current time.

16. The system of claim 15, wherein:
the encoded files further include, at each of multiple encoding bitrates, encoded files having successive time codes;
the selection criteria specifies an encoding bitrate of one of the encoding profiles; and
the RTS is further configured to select the encoded files associated with an encoding bitrate that matches the specified encoding bitrate.

17. The system of claim 13, wherein the playlist includes, for each identified file:
an address where the identified file is stored;
a time code associated with the identified file; and
a size of the identified file.

18. The system of claim 13, wherein:
the encoded files contain corresponding content encoded in accordance with encoding profiles including encoding parameters;
the RTS is further configured to send the encoding profiles to the client; and
the encoded file selection criteria are based in part on the encoding profiles.

19. The system of claim 18, wherein:
the encoding profiles include encoding levels each specifying an encoding bitrate and a corresponding resolution;
the encoded file selection criteria specifies at least one of the encoding levels; and
the RTS is further configured to select the encoded files that match the specified at least one of the encoding levels.

20. The system of claim 13, further comprising an encoder to encode successive blocks of content according to the encoding profiles to produce the encoded files.

21. The system of claim 20, wherein:
the encoder is further configured to encode the successive blocks to produce, at each of multiple encoding bitrates, encoded files having successive time codes;
the selection criteria specify an encoding bitrate; and
the RTS is further configured to select the encoded files associated with an encoding bitrate that matches the specified encoding bitrate.

22. The system of claim 20, further comprising a download server to store the encoded files, wherein the download server is configured to access requests from the client to download the selected files identified in the playlist.

23. A non-transitory computer readable mediums encoded with a computer program including instructions to cause a processor to:
receive a request to stream the multimedia content to a client;
receive information identifying encoded files that encode the multimedia content;
receive from the client a playlist request relating to the content, the playlist request including encoded file selection criteria;
select among the encoded files based on the information identifying the encoded blocks and the selection criteria; and
send to the client a playlist identifying the selected files.

24. The computer readable medium of claim 22, wherein:
the encoded files include encoded files that each encode a corresponding one of successive blocks of content and are associated with successive time codes;
the selection criteria include a current time; and
the instructions to cause the processor to select further include instructions to cause the processor to select the encoded files associated with time codes that are greater than the current time.

25. The computer readable medium of claim 24, wherein:
the encoded files further include, at each of multiple encoding bitrates, encoded files having successive time codes;
the selection criteria specifies an encoding bitrate of one of the encoding profiles; and
the instructions to cause the processor to select further include instructions to cause the processor to select the encoded files associated with an encoding bitrate that matches the specified encoding bitrate.

26. The computer readable medium of claim 23, wherein the playlist includes, for each identified file:
an address where the identified file is stored;
a time code associated with the identified file; and
a size of the identified file.

27. The computer readable medium of claim 23, wherein:
the encoded files contain corresponding content encoded in accordance with encoding profiles including encoding parameters;
the instructions further include instructions to cause the processor to send the encoding profiles to the client; and
the encoded file selection criteria are based in part on the encoding profiles.

28. The computer readable medium of claim 27, wherein:
the encoding profiles include encoding levels each specifying an encoding bitrate and a corresponding resolution;
the encoded file selection criteria specifies at least one of the encoding levels; and
the instructions to cause the processor to select further include instructions to cause the processor to select the encoded files that match the specified at least one of the encoding levels.

29. The computer readable medium of claim 23, wherein the instructions further include instructions to cause the processor to:
encode successive blocks of content to produce corresponding encoded files; and
store the encoded files.

30. The computer readable medium of claim 29, wherein:
instructions to cause the processor to encode further include instructions to cause the processor to encode the successive blocks to produce, at each of multiple encoding bitrates, encoded files having successive time codes;
the encoded file selection criteria specify an encoding bitrate; and
the instructions to cause the processor to select further include instructions to cause the processor to select the encoded files associated with an encoding bitrate that matches the specified encoding bitrate.

31. A system to control streaming of multimedia content, comprising:
a real-time server (RTS); and
an encoder,
wherein the RTS is configured to:
receive a request from a client to stream the multimedia content to the client; and
send encoding profiles to the client;
wherein the encoder is configured to:
encode successive blocks of the content to produce encoded files; and
provide information identifying the encoded files to the RTS; and
wherein the RTS is further configured to:
receive from the client a playlist request relating to the content, the playlist request including encoded file selection criteria;
select among the encoded files based on the selection criteria; and
send to the client a playlist identifying the selected files.

32. The system of claim 1, further comprising a download server to:
store the encoded files; and
service access requests from the client to download the selected files identified in the playlist.
